(19) United States
(12) Patent Application Publication
(10) Pub. No.: US 2006/0003141 A1
(43) Pub. Date: Jan. 5, 2006

(54) Floor covering having a removable decorative inlay

(76) Inventor: Joseph R. Pacione, Newmarket (CA)

Correspondence Address: MCCARTHY TETRAULT LLP, BOX 48, SUITE 4700,, 66WELLINGTON STREET WEST, TORONTO, ON, M5K 1E6, CA

(21) Appl. No.: 10/879,149

(22) Filed: Jun. 30, 2004

(51) Int. Cl. B32B 3/14; B32B 3/16

(52) U.S. Cl. 428/95; 428/77; 428/79; 428/67; 428/99

(57) ABSTRACT

A floor covering including a carrier sheet having a first and second side, the first side being substantially covered in loops for attachment to a field of hooks covering a floor. The floor covering has a decorative inlay attached to the second side of the carrier sheet, and the decorative inlay has a visually distinct design. At least one fill piece is attached to the second side of the carrier sheet to fill the remaining exposed surface of the second side around the decorative inlay. The carrier sheet may be of a size and shape that, when placed onto the field of hooks with the decorative inlay and fill piece attached thereto, permits it to integrate with at least one decorative piece covering the remaining field of hooks, without the need for substantial cutting or trimming of the decorative piece.

### FIELD OF THE INVENTION

This invention relates to a covering for a floor, in which the covering has a removable decorative inlay. The decorative inlay has a looped underside for attachment to a field of hooks. The inlay itself is composed of a plurality of decorative pieces which are attached to a carrier sheet which is itself secured by a hook and loop attachment system to an underlying anchor sheet or other floor or floor covering containing a field of hooks. The decorative pieces may be attached to the carrier sheet by a hook and loop attachment system.

### BACKGROUND OF THE INVENTION

Over the past several years, attempts have been made at incorporating hook and loop (e.g., Velcro (™)) technology into floor coverings, particularly carpeting. There are several advantages to the use of such technology. It is environmentally friendly, permitting connection of flooring components in situ without the use of glues that release volatile organics. Hook and loop technology provides a robust connection, but one that is at the same time releasable, presenting advantages during installation and permitting replacement of damaged pieces, etc.

An example of the use of hook and loop technology in the field of carpets is described in U.S. Pat. No. 4,822,658, which issued to Pacione on Apr. 14, 1989. The specification of this patent shows a carpet having loops across its underside for attachment along its edges by means of hooked strips secured to a floor to be covered by the carpet.

Hook and loop attachment systems, in respect of flooring, provide an opportunity for creation of carpet units from multiple pieces to create interesting designs.

More recently, use of anchor sheets to cover, more or less, an entire area to be carpeted has been described in U.S. Pat. No. 6,306,477, which issued to Pacione on Oct. 23, 2001. Such an anchor sheet is described in a more detailed way in international patent application No. PCT/CA 00/00681, that was published under WO 00/74544 on Dec. 14, 2000, and names Pacione as the inventor. Each of these cases describes a final carpet construction in which multiple carpet pieces are attached across the surface of an underlayment made up of multiple anchor sheets. The present invention relates to this sort of arrangement.

### SUMMARY OF THE INVENTION

In accordance with one broad aspect of the invention there is provided a floor covering having: (i) a carrier sheet having a first and second side, the first side being substantially covered in loops for attachment to a field of hooks covering a floor; (ii) a decorative inlay attached to the second side of the carrier sheet, the decorative inlay having a visually distinct design; and (iii) at least one fill piece attached to the second side of the carrier sheet, to fill the remaining exposed surface of the second side around the decorative inlay.

According to an embodiment of the invention, the carrier sheet may be of a size and shape that, when placed onto the field of hooks with the decorative inlay and fill piece attached thereto, permits it to integrate with at least one decorative piece covering the remaining field of hooks, without the need for substantial cutting or trimming of the decorative piece.

Conveniently, the at least one fill piece may have an appearance that permits it to visually integrate with the at least one decorative piece when the carrier sheet is placed onto the field of hooks and the remaining field of hooks is covered by the at least one decorative piece.

According to another embodiment of the invention, the fill piece is at least one of the same colour, shape and material as the decorative piece.

According to a further embodiment of the invention, the carrier sheet is of a size and shape that, when placed onto the field of hooks, fits within an opening defined by at least one decorative piece covering the remaining field of hooks, without the need for substantial cutting or trimming of the decorative piece. The carrier sheet may be of a uniform geometric shape, including a rectangular shape. The decorative inlay may also be made of at least four distinct pieces.

According to an embodiment of the invention, the second side of the carrier sheet is substantially covered in hooks and the decorative inlay has a side substantially covered in loops for detachable attachment to the second side of the carrier sheet. Furthermore, the second side of the carrier sheet may be substantially covered in hooks and the at least one fill piece has a side substantially covered in loops for detachable attachment to the second side of the carrier sheet.

In an embodiment, the decorative inlay is made from at least one of the materials selected from the group consisting of wood, ceramic, stone, carpet, rubber, plastic, vinyl, linoleum and metal. Furthermore, at least one fill piece may be made from at least one of the materials selected from the group consisting of wood, ceramic, stone, carpet, rubber, plastic, vinyl, linoleum and metal.

According to a yet further embodiment of the invention, the carrier sheet, having the decorative inlay and at least one fill piece attached thereto, may be of a size and shape that it fits within an exposed area of the field of hooks revealed by the removal of at least one decorative piece covering the field of hooks without the need to cut or trim any remaining decorative piece that covers the field of hooks. The carrier sheet, having the decorative inlay and at least one fill piece attached thereto, may be of a size and shape that it does not require cutting or trimming to fit within an exposed area of the field of hooks revealed by the removal of at least one decorative piece covering the field of hooks.

According to an embodiment of the invention, the carrier sheet has a thickness of from 0.1 mm to 2 mm (not including the hooks or loops thereof).

According to another aspect of the invention, there is provided: (i) a carrier sheet having a first and second side, the first side being substantially covered in loops for attachment to a field of hooks covering a floor; (ii) a decorative inlay attached to the second side of the carrier sheet, the decorative inlay having a visually distinct design; and (iii) at least one fill piece attached to the second side of the carrier sheet, to fill some but not all of the remaining exposed surface of the second side around the decorative inlay. Furthermore, at least one fill piece may be of a size and shape that, when the carrier sheet is placed onto the field of hooks, permits it to integrate with at least one decorative piece covering the remaining exposed surface of the carrier sheet, without the need for substantial trimming of the decorative piece.

According to a yet further aspect of the invention, there is provided: (i) a rectangular carrier sheet having a first and second side, the first side being substantially covered in loops for attachment to a field of hooks covering a floor, and the second side being substantially covered in hooks; (ii) a decorative inlay made of at least four pieces of carpet and covered in loops on one side attached to the second side of the carrier sheet, the decorative inlay having a visually distinct design; and (iii) at least one fill piece made of carpet attached to the second side of the carrier sheet, to fill the remaining exposed surface of the second side around the decorative inlay; and (iv) wherein the carrier sheet, having the decorative inlay and fill piece pre-assembled thereto, when placed onto the field of hooks, integrates with decorative carpet pieces covering the remaining field of hooks, without the need for substantial trimming of the decorative pieces.

According to another broad aspect of the invention, there is provided a method of creating a floor covering as follows:

(i) laying a field of hooks on a floor;

(ii) assembling at least one decorative inlay having a non-decorative side substantially covered in loops onto a hooked surface of a carrier sheet;

(iii) filling in the remaining exposed surface of the second side of the carrier sheet around the decorative inlay with at least one fill piece attached to the second side of the carrier sheet;

(iii) detachably attaching a looped surface of the carrier sheet onto the field of hooks; and

(iv) attaching at least one decorative piece having a bottom side substantially covered in loops onto the field of hooks surrounding the carrier sheet, the at least one fill piece and decorative piece together creating an integrated field or background for the decorative inlay without the need to trim the decorative piece.

According to another broad aspect of the invention, there is provided a method of creating a floor covering as follows:

(i) laying a field of hooks on a floor;

(ii) attaching at least one decorative piece having a bottom side substantially covered in loops onto the field of hooks to define an area of uncovered hooks;

(iii) assembling at least one decorative inlay having a non-decorative side substantially covered in loops onto a hooked surface of a carrier sheet, the carrier sheet being substantially similar in size and shape to the area of uncovered hooks;

(iv) filling in the remaining exposed surface of the second side of the carrier sheet around the decorative inlay with at least one fill piece attached to the second side of the carrier sheet; and

(v) detachably attaching the carrier sheet onto the area of uncovered hooks, the at least one fill piece and decorative piece together creating a field or background for the decorative inlay.

In one preferred embodiment, the first set of decorative pieces are carpet pieces, and the second set of decorative pieces are also carpet pieces. The first set in additional aspects of the invention, usually comprises groupings of carpet pieces, often in intricate patterns, to create coats of arms, pictures, ornamental medallions, and any other intricate and complicated form of design.

In a preferred embodiment, the invention is suited for complicated designs which can be pre-installed on a carrier sheet in a factory or other location, transported to a site to be installed as a design element into a field of hooks at a flooring site.

In other aspects of the invention, the design could be carpet, ceramic, stone, metal, wood, or other suitable material, which can be installed onto the carrier sheet using a hook and loop attachment system or permanently installed on, or bonded to, the carrier sheet so that such a design can be inset into a larger field of carpet or other material that has been installed on the field of hooks.

In another aspect of the invention, the pieces (for instance carpet) installed on the carrier sheet, can be the same height as the pieces in the surrounding “fill” and are installed directly onto the field of hooks. In this way, the decorative inlay will be very slightly raised above the surface of the surrounding carpet materials.

In another aspect of the invention, the inlay can be of a thinner or thicker or the same material than the surrounding “fill”, thereby creating other design possibilities.

Related to the invention(s) disclosed herein are invention(s) in the following U.S. provisional patent applications:
U.S. Provisional Patent Application 60/443,576 entitled “Carpet tile, installation, and methods of manufacture and installation thereof”, filed Jan. 30, 2003 and incorporated herein by reference;
U.S. Provisional Patent Application 60/443,561 entitled “System and methods of manufacturing hook-plates”, and filed Jan. 30, 2003 and incorporated herein by reference;
U.S. Provisional Patent Application 60/443,564 entitled “Improved anchor sheet”, and filed Jan. 30, 2003 and incorporated herein by reference;
U.S. Provisional Patent Application 60/443,565 entitled “Ultrasonic welding of resilient layers to plates”, and filed Jan. 30, 2003; and
U.S. Provisional Patent Application 60/443,563 entitled “Anchor sheet positioning and connection system”, and filed Jan. 30, 2003.

### BRIEF DESCRIPTION OF THE DRAWINGS

Particular embodiments of the invention are described below with reference to the accompanying drawings, in which:

FIG. 1 shows a prior art floor tile that includes multiple carpet pieces attached to a carrier sheet;

FIG. 2 shows an installation of a decorative inlay of the present invention attached to a field of hooks created by an anchor sheet subfloor;

FIG. 3 shows an installation in which the decorative inlay of FIG. 2 has carpet pieces as surrounding “fill” attached to the carrier sheet;

FIG. 3A shows an installation in which the carrier sheet is larger than the decorative inlay and “fill” carpet pieces;

FIG. 4 shows a cross-section of the installation of FIG. 3 taken along line 4-4 of FIG. 3;

FIG. 5 is a sectional type view of a preferred carpet construction for use with the present invention;

FIG. 6 is a sectional type view of a preferred carrier sheet for use with the present invention;

FIG. 7 is a sectional type view of a preferred anchor sheet for use with a carrier sheet.

### DETAILED DESCRIPTION OF EMBODIMENTS OF THE INVENTION

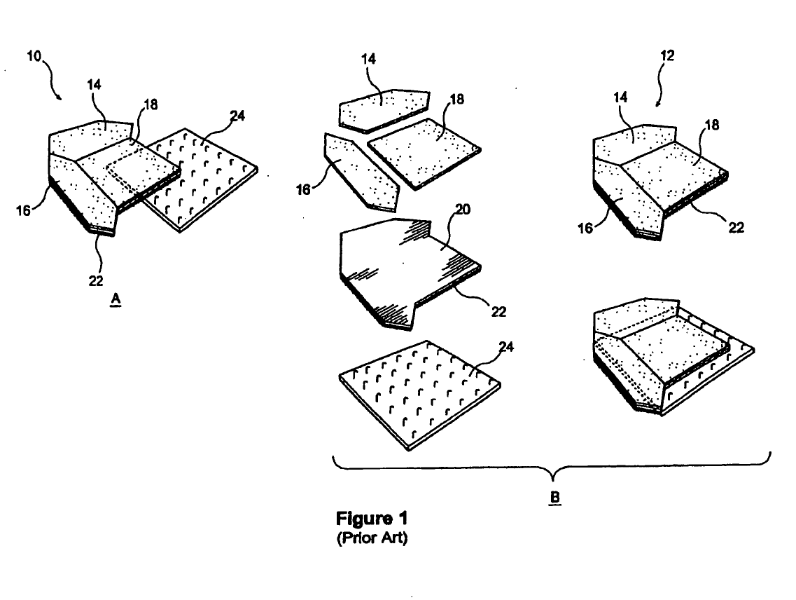

Turning to the drawings, FIG. 1 shows prior art carpet tiles 10, 12. This drawing is based on FIG. 29 contained in the specification of U.S. Pat. No. 6,298,624, which issued on Oct. 9, 2001 and FIG. 1 of Patent Co-operation Treaty Application No. PCT/CA2004/000123 which was filed Jan. 29, 2004, both by the inventor named herein, and both are incorporated herein by reference. Each tile includes multiple carpet pieces 14, 16, 18 which are assembled onto carrier sheet 20, having loops 22 on its underside, to create a unit for installation onto piece 24. This creates a module as shown in FIG. 1B, that can be used and installed in an overlapping fashion with other modules as shown in the '624 Patent.

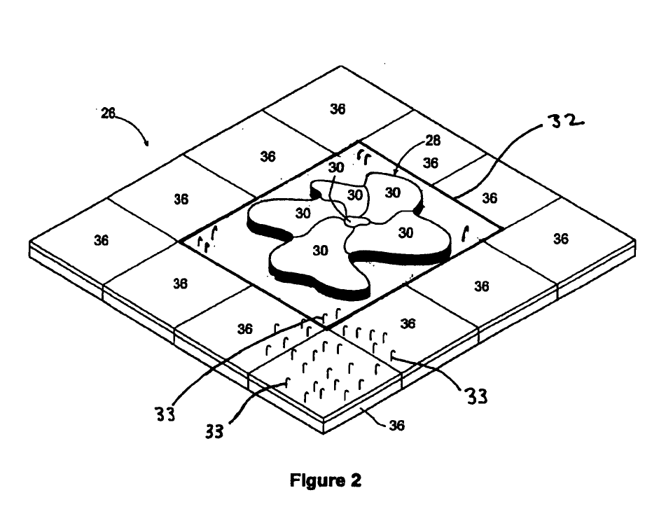

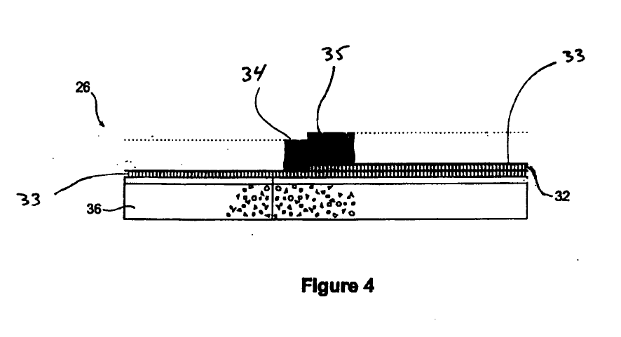

One aspect of the present invention is shown in FIGS. 2, 3, and 4. A carpet installation 26 is shown. It includes a decorative inlay 28 in one preferred embodiment carpet installation. The inlay is made up of carpet pieces 30 attached to a carrier sheet 32. The decorative inlay 28 is formed from one or more carpet pieces 30 and carrier sheet 32 is attached to a field of hooks 33 created by anchor sheets 36. In the figures, the hooks are generally shown as larger than they would be in an actual installation. Also, for illustrative purposes, fewer hooks are shown than would actually be used.

One or more carpet pieces 35 provide a “fill” or background to the decorative inlay 28 and are also installed onto the hooks of carrier sheet 32 that are not covered by decorative inlay 28. One or more carpet pieces 34 are used to cover the remainder of the floor area around carrier sheet 32 and are installed directly onto the hooks of anchor sheets 36. Carrier sheet 32 is preferably relatively thin in relation to the thickness of carpet pieces 30, 34 and 35. For example, carrier sheet 32 preferably has a thickness that falls in the range from 0.1 mm to 2 mm, not including the hooks or loops thereof Carpet pieces 35 are typically in the range of thickness from about 3/16 of an inch to 2 inches, but could conceivably be thicker or thinner.

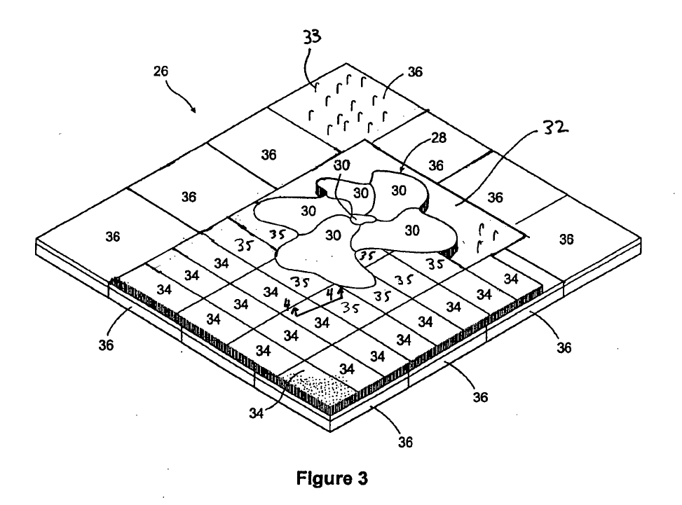

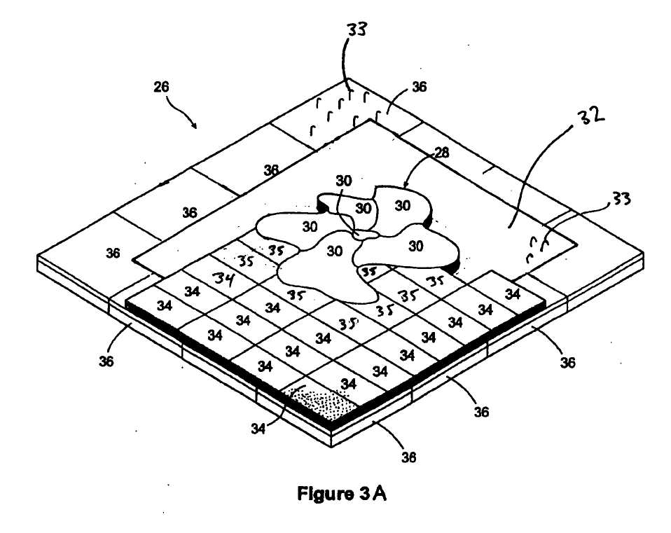

Carrier sheet 32 is preferably rectangular in shape. Carpet pieces 35 are positioned, and cut, if necessary, to fill the area of carrier sheet 32 that is not covered by decorative inlay 28 (for illustrative purposes, not all pieces 34 and 35 are shown installed in FIG. 3). If decorative inlay 28 substantially covers carrier sheet 32, then carpet pieces 35 are not required. Carrier sheet 32 may then be placed on a field of hooks provided by anchor sheets 36. The remaining exposed hooks of anchor sheets 36 may be covered by carpet pieces 34. Since carrier sheet 32 is preferably rectangular, rectangular carpet pieces 34 may be positioned adjacent carpet pieces 35, without the need to cut or trim carpet pieces 34 to fit. While carrier sheet 32 is shown in FIG. 2 aligned with edges of anchor sheets 36, carrier sheet 32 may be placed anywhere on the field of hooks created by anchor sheets 36.

Alternatively, carpet pieces 34 may be placed onto anchor sheets 36 and positioned to leave an exposed area of anchor sheets 36 for placement of carrier sheet 32. In the present embodiment, carpet pieces 34 are rectangular and may be positioned to define a rectangular exposed area without the need to cut or trim the carpet pieces 34 bounding the exposed area. Carrier sheet 32 may then be placed onto the exposed anchor sheets 36 to substantially fill the exposed area.

While carpet pieces 34 are typically rectangular, they may have some other shape such as triangular (not shown). A single piece of carpet 34 having an opening or rebate formed therein may also be used. If triangular carpet pieces 34 are used, then various non-rectangular exposed areas may be defined (e.g., hexagonal), without the need to cut or trim carpet pieces 34. If triangular carpet pieces 34 are used, then carrier sheet 32 is preferably the same shape as the area exposed, e.g., hexagonal. Carpet pieces 35 are trimmed accordingly to fit the shape of carrier sheet 32 and decorative inlay 28. Alternatively, if carpet pieces 35 are a complementary size and shape to carpet pieces 34, then carpet pieces 35 will usually only need to be trimmed to lie adjacent decorative inlay 28. For example, if carpet pieces 35 are triangular, then they may be positioned to match the hexagonal boundary of the carrier sheet 32, without the need to trim them at the boundary.

Carrier sheets 32 having decorative inlays 28 and “fill in” or “fill” carpet pieces 35 may conveniently be cut and pre-assembled at a central location, such as a factory, and then installed as a single unit where a floor covering is being installed. This can reduce the amount of cutting and trimming required at the job site to install the decorative inlay because the shape of the carrier sheet 32 is configured to match the area exposed by carpet pieces 34. (As noted, the carrier sheet may alternatively be installed first with the remainder of the floor being filled in by carpet pieces 34 afterward.) As a result, there may be a reduced need for specialized cutting equipment and skilled installers at the installation site.

In an alternative embodiment, shown in FIG. 3A, the carrier sheet may be bigger than the combined decorative inlay 28 and carpet pieces 35 (for illustrative purposes, not all pieces 34 and 35 are shown installed in FIG. 3A). In this embodiment, decorative inlay 28 and carpet pieces 35 are arranged in a similar manner to that described above. As before, the carrier sheet is placed onto the field hooks provided by anchor sheets 36. Carpet pieces 34 are then placed onto the remaining exposed area of carrier sheet 32 adjacent carpet pieces 35 and the remainder of the exposed hooks 33 of anchor sheets 36 (carpet pieces 34 may alternatively be placed onto the anchor sheets 36 and then on to the exposed carrier sheet 32). If the carrier sheet is installed in this manner, then the particular shape of the carrier sheet is less important, as long as carpet pieces 35 are assembled to permit the installation of carpet pieces 34 in the manner described above. Due to the thickness of carrier sheet 32, this embodiment may not be as visually pleasing as other embodiments. This is because it might be noticeable that carpet pieces 34 are not at a uniform level in the area adjacent the edge of carrier sheet 32.

Anchor sheets 36 may initially be installed with carpet pieces 34 or other decorative covering attached to substantially the entire field of hooks provided by anchor sheets 36. One or more carpet pieces 34 may be subsequently removed to reveal hooks 33 of the anchor sheets. This may be done to permit the addition of a decorative feature or inlay in place of the removed covering. Carrier sheet 32 may be cut or trimmed or otherwise configured to have a size and shape that corresponds to the exposed area of the field of hooks revealed by the removal of carpet piece 34. This reduces or eliminates the need to cut or trim any of the remaining decorative piece or pieces 34 that cover the field of hooks. With decorative inlay 28 and at least one fill piece 35 attached to carrier sheet 32, the exposed area may be conveniently covered by placing similarly shaped carrier sheet 32 thereon. If carpet pieces 34 are geometrically shaped, then the removal thereof will reveal a geometrically shaped exposed area of anchor sheet hooks 33. Carrier sheet 32 is accordingly configured to a similar same size and shape as the exposed area to permit convenient placement therein. As a result, attached decorative inlay 28 and fill pieces 35, which together substantially cover a surface of carrier sheet 32, may replace the removed carpet piece or pieces 34.

Accordingly, in at least one embodiment, the design or decorative inlay 28 (with the fill pieces 35, if needed) when combined with carrier sheet 32 conveniently fits into the regular geometric shape created from the regular geometric patterns of the carpet tiles 34.

In many embodiments carpet pieces 30, 34 and 35 can be made to have the same construction as each other, or of a different construction from each other. For example, if carpet pieces 30, 34, and 35 have the same thicknesses and weight, and carpet pieces 34 and 35 are the same color and shape, then decorative inlay 28 may appear to be an integral part of the overall carpet, and carpet pieces 34 and 35 may appear to be somewhat visually indistinguishable. Because carrier sheet 32 is of a relatively low profile in relation to the thickness of the carpet, the decorative inlay 28 and carpet 35 will only be very slightly raised above the surrounding carpet 34. This possible height differential preferably is not sufficient to create an impediment to walking.

In an alternative embodiment, carpet piece 34 can be made to have a different thickness than carpet pieces 30 and 35. For example, carpet pieces 34 may be made to have a greater thickness than carpet pieces 30 and 35. The increased thickness of carpet pieces 34 may be made to correspond to the thickness of carrier sheet 32. This may be done to accommodate for the thickness added by carrier sheet 32 so that the decorative inlay 30 is at the same height as the “field” created by carpet pieces 34 and 35. Alternatively, two or more of carpet pieces 30, 34, and 35 may have different thicknesses, shapes and/or colours to create various visual effects, such as making decorative inlay 28 appear sunken or raised in relation to carpet pieces 34 and 35.

In a further alternative embodiment, one or more of carpet pieces 30, 34, and 35 can be made of some other suitable material, such as stone, ceramic, marble, or even metal. In a preferred form, the pieces are provided with a loop backing and the carrier sheet has a top side covered in hooks.

Further alternatively, the decorative pieces can be permanently attached to the carrier sheet. Since the carrier sheet will have loops on the back for detachable attachment to the underlying field of hooks, the permanent attachment of pieces 30 and/or 35 to carrier sheet 32 is not of concern, as presumably the decorative inlay operates as a stand alone separate unit that can be moved, transported and reinserted in another background or field as desired.

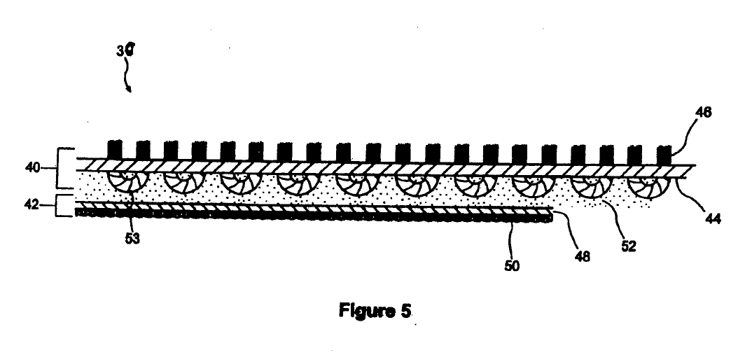

In a preferred embodiment, the carpet, for example carpet 30, is constructed in accordance with the carpet construction shown in the above-detailed application entitled “Carpet Tile, Installation, and Methods of Manufacture.” As shown in FIG. 5, typically, such carpet is a laminate made up of an upper first layer 40 and a lower second layer 42. The first layer 40 of the carpet includes a nonwoven primary backing 44 into which is needle pile yarn 46. Second layer 42 includes secondary backing 48 to which are attached lower loops 50. The layers are secured to each other by hot melt adhesive 52.

Again, typically the primary backing 44 is a nonwoven fabric. Pile yarn 46 is tufted into primary backing 44.

One preferred secondary layer 42 is a tricot knit, supplied by Guilford Mills, Inc. of Greensboro, N.C. Typically, such a tricot knit forms a dense substrate which provides for loops 50 on the underside of the secondary backing 48, which tricot precludes most, if not all, bleeding of hot melt 52 into the loops. Excessive bleeding, of course, is to be avoided as this could interfere with the function of the loops as fasteners.

First and second layers 40, 42 are attached to each other by hot melt layer 52 which also encapsulates tufts 53. One particular adhesive used is an ethylene-vinyl acetate-based adhesive known as XP-025 provided by Barrier-Bac, Inc. of Calhoun, Ga. The adhesive is substantially free of filler, organic and inorganic. The overall weight of the carpet of the present invention is approximately 80-100 oz per square yard. It will thus be appreciated that it is possible, according to the invention, to have a carpet, and carpet tile, with a relatively lightweight secondary backing. Such a backing lacks a stabilizing layer and, as is explained below, is relatively free of filler. Such a carpet or carpet tile has little or no inherent dimensional stability of its own in relation to externally applied physical forces, such as stretching forces, forces exerted in use by rolling machinery, furniture movement, etc.

The carpet laminate can eventually be cut into tiles at some convenient point. This enables a decorative inlay to be created from numerous carpet pieces. Such pieces installed on a carrier sheet in a factory or other location, can have a complicated pattern, but, as they exist as a self-contained unit on the carrier sheet, can be transported to a site, and installed separately. They can also be removed when a change is desired.

With the carpet described above, combined with a field of hooks, it is possible to make a carpet tile of any shape and size to order. Even small carpet tiles, e.g., 2″×2″ can be easily incorporated into carpet installation. The carpet laminate can be cut through the back or the front by, for example, an ultrasonic cutting cutter on a plotting table. The cutter can be controlled by software to make any form of pattern or design.

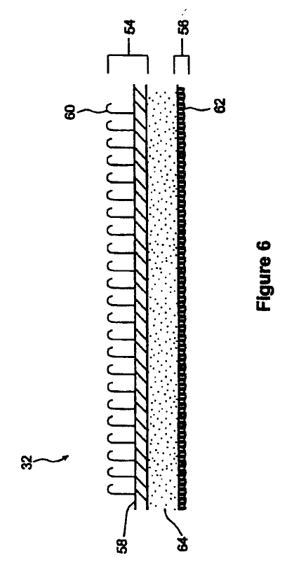

Carrier sheet 32 is illustrated separately in FIG. 6. Carrier sheet may include upper layer 54 and lower layer 56. Upper layer 54, manufactured of polypropylene, includes base sheet 58 and hooks 60 across the upper side of the sheet. The whole carrier sheet is designed to carry individual pieces of carpet to form a decorative inlay surrounded by fill carpet 35 to permit convenient integration of the decorative inlay and carpet 34 of a carpet installation. Generally speaking, it is desired to have the profile of carrier sheet 32 to be as thin as possible, so as not to raise the decorative inlay and fill carpet 35 above the surrounding carpet 34, other than, perhaps, a small amount without impairing the ability of a person or persons to walk over the decorative inlay 28 and carpet 35.

One particular carrier sheet of the invention includes two extruded sheets of polypropylene, which are secured together by a hot melt, typically EVA hot melt. Other materials may be used for the carrier sheet including other plastics or polymers. The thickness of each two extruded sheets (not taking into account hooks and loops) is about 0.3 mm, and the bonding layer is about 0.1 mm. There are alternatives to these sheets commercially available, and, as mentioned, the carrier sheet may be as thin as 0.1 mm. Thicker carrier sheets may be used, but will likely be more noticeable when installed by raising the level of any attached pieces (e.g., carpet or decorative inlay). This may be desirable in some installations. Lower layer 56 of the carrier sheet provides the carrier sheet with loops 62 across the underside of the sheet. Layer 56 can have the same tricot construction of second layer 42 of carpet 36 described above. Layers 54 and 56 are secured to each other by EVA hot melt 64.

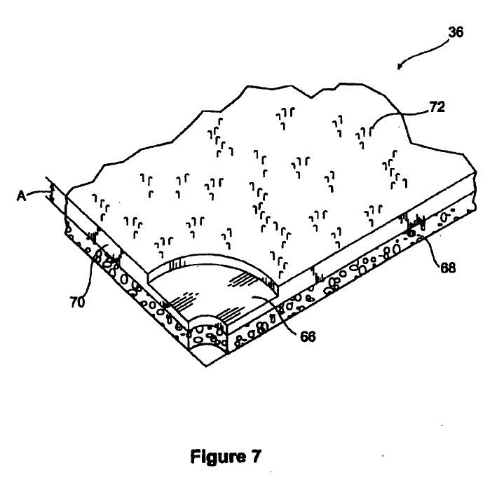

Anchor sheet 36 is illustrated separately in FIG. 7. The preferred embodiment is manufactured in accordance with the description provided in the above-detailed applications entitled “System and methods of Manufacturing hook-plates” and “Improved anchor sheet”. The thickness of anchor sheet A is about ⅛ inches, and the thickness of the anchor sheet at 66 is about 1/16 inches. The corner of the anchor sheet includes a counter sunk area attachment, for attaching, if desired, to other anchor sheets, or to an underlying floor, as described in WO 0/74544 published Dec. 14, 2000. The anchor sheet 36 includes a cushion 68 of thickness that can be either approximately ¼ inches, or ⅜ inches depending on the desired resiliency and the amount of surface traffic. The hooks 72 of the top surface layer 70 will have a density that may range from 160-1200 hooks/square inch, with a preferred density of approximately 230 hooks/square inch.

The preferred material for the top surface layer 70 is polypropylene and the cushion 68 is polyethylene. In a preferred embodiment, the cushion 68 is made from linear load density polyethylene with a density of approximately 30 kg/m³.

With the floor covering having a decorative inlay formed by an additional carrier sheet, complicated decorative inlays can be pre-made and installed into a surrounding field or background.

Such decorative inlays can be moved or replaced to change the look of a floor immediately and inserted and removed to provide features such as a family crest, cartoon character, team crest, or any other preferred design. Decorative inlays can easily be sold as a unit for insertion into a surrounding field of hooks and can appeal to particular categories of consumers, children, sports fans, music lovers, or virtually any category where a specific design can be incorporated into a carpet or other decorative inlay as desired.

The invention disclosed in this preferred embodiment is just one aspect of the invention which is intended to be defined by the claims which follow.

I claim:

1. A floor covering comprising:
(i) a carrier sheet having a first and second side, the first side being substantially covered in loops for attachment to a field of hooks covering a floor;
(ii) a decorative inlay attached to the second side of the carrier sheet, the decorative inlay having a visually distinct design; and
(iii) at least one fill piece attached to the second side of the carrier sheet, to fill the remaining exposed surface of the second side around the decorative inlay.

2. The floor covering of claim 1 wherein the carrier sheet is of a size and shape that, when placed onto the field of hooks with the decorative inlay and fill piece attached thereto, permits it to integrate with at least one decorative piece covering the remaining field of hooks, without the need for substantial cutting or trimming of the decorative piece.

3. The floor covering of claim 2, wherein the at least one fill piece has an appearance that permits it to visually integrate with the at least one decorative piece when the carrier sheet is placed onto the field of hooks and the remaining field of hooks is covered by the at least one decorative piece.

4. The floor covering of claim 3, wherein the fill piece is at least one of the same colour, shape and material as the decorative piece.

5. The floor covering of claim 1 wherein the carrier sheet is of a size and shape that, when placed onto the field of hooks, fits within an opening defined by at least one decorative piece covering the remaining field of hooks, without the need for substantial cutting or trimming of the decorative piece.

6. The floor covering of claim 1 wherein the carrier sheet is a uniform geometric shape.

7. The floor covering of claim 1 wherein the carrier sheet is rectangular.

8. The floor covering of claim 1 wherein the decorative inlay is made of at least four distinct pieces.

9. The floor covering of claim 1 wherein the second side of the carrier sheet is substantially covered in hooks and the decorative inlay has a side substantially covered in loops for detachable attachment to the second side of the carrier sheet.

10. The floor covering of claim 1 wherein the second side of the carrier sheet is substantially covered in hooks and the at least one fill piece has a side substantially covered in loops for detachable attachment to the second side of the carrier sheet.

11. The floor covering of claim 1 in which the carrier sheet is of a thickness substantially less than the thickness of the at least one fill piece.

12. The floor covering of claim 1 in which the decorative inlay and the at least one fill piece have different thicknesses.

13. The floor covering of claim 1 in which at least one of the fill piece and decorative inlay is carpet.

14. The floor covering of claim 1 in which the decorative inlay is made from at least one of the materials selected from the group consisting of wood, ceramic, stone, carpet, rubber, plastic, vinyl, linoleum and metal.

15. The floor covering of claim 1 in which the at least one fill piece is made from at least one of the materials selected from the group consisting of wood, ceramic, stone, carpet, rubber, plastic, vinyl, linoleum and metal.

16. The floor covering of claim 2 in which the thickness of the at least one fill piece is less than the at least one decorative piece by an amount which substantially equals the thickness of the carrier sheet.

17. The floor covering of claim 14 in which the carrier sheet has a thickness of from 0.1 mm to 2 mm and the carpet piece have a thickness of from 3/16 inches to 2 inches.

18. The floor covering of claim 15 in which the carrier sheet has a thickness of from 0.1 mm to 2 mm and the carpet piece has a thickness of from 3/16 inches to 2 inches.

19. The floor covering of claim 1, wherein the carrier sheet, having the decorative inlay and at least one fill piece attached thereto, is of a size and shape that it fits within an exposed area of the field of hooks revealed by the removal of at least one decorative piece covering the field of hooks without the need to cut or trim any remaining decorative piece that covers the field of hooks.

20. The floor covering of claim 19, wherein the exposed area is geometrically shaped.

21. The floor covering of claim 1, wherein the carrier sheet, having the decorative inlay and at least one fill piece attached thereto, is of a size and shape that it does not require cutting or trimming to fit within an exposed area of the field of hooks revealed by the removal of at least one decorative piece covering the field of hooks.

22. The floor covering of claim 21, wherein the exposed area is geometrically shaped.

23. The floor covering of claim 9 in which the carrier sheet has a thickness of from 0.1 mm to 2 mm (not including the hooks or loops thereof).

24. A floor covering comprising:
(i) a carrier sheet having a first and second side, the first side being substantially covered in loops for attachment to a field of hooks covering a floor;
(ii) a decorative inlay attached to the second side of the carrier sheet, the decorative inlay having a visually distinct design; and
(iii) at least one fill piece attached to the second side of the carrier sheet, to fill some but not all of the remaining exposed surface of the second side around the decorative inlay.

25. The floor covering of claim 24 wherein the at least one fill piece is of a size and shape that, when the carrier sheet is placed onto the field of hooks, permits it to integrate with at least one decorative piece covering the remaining exposed surface of the carrier sheet, without the need for substantial trimming of the decorative piece.

26. A floor covering comprising:
(i) a rectangular carrier sheet having a first and second side, the first side being substantially covered in loops for attachment to a field of hooks covering a floor, and the second side being substantially covered in hooks;
(ii) a decorative inlay made of at least four pieces of carpet and covered in loops on one side attached to the second side of the carrier sheet, the decorative inlay having a visually distinct design; and
(iii) at least one fill piece made of carpet attached to the second side of the carrier sheet, to fill the remaining exposed surface of the second side around the decorative inlay; and
(iv) wherein the carrier sheet, having the decorative inlay and fill piece pre-assembled thereto, when placed onto the field of hooks, integrates with decorative carpet pieces covering the remaining field of hooks, without the need for substantial trimming of the decorative pieces.

27. A method of creating a floor covering comprising:
(i) laying a field of hooks on a floor;
(ii) assembling at least one decorative inlay having a non-decorative side substantially covered in loops onto a hooked surface of a carrier sheet;
(iii) filling in the remaining exposed surface of the hooked surface of the carrier sheet around the decorative inlay with at least one fill piece attached to the hooked surface of the carrier sheet;
(iii) detachably attaching a looped surface of the carrier sheet onto the field of hooks; and
(iv) attaching at least one decorative piece having a bottom side substantially covered in loops onto the field of hooks surrounding the carrier sheet, the at least one fill piece and decorative piece together creating an integrated field or background for the decorative inlay without the need to trim the decorative piece.

28. The method of claim 27, wherein the decorative inlay is made of at least four distinct pieces.

29. A method of creating a floor covering comprising:
(i) laying a field of hooks on a floor;
(ii) attaching at least one decorative piece having a bottom side substantially covered in loops onto the field of hooks to define an area of uncovered hooks;
(iii) assembling at least one decorative inlay having a non-decorative side substantially covered in loops onto a hooked surface of a carrier sheet, the carrier sheet being substantially similar in size and shape to the area of uncovered hooks;
(iv) filling in the remaining exposed surface of the hooked surface of the carrier sheet around the decorative inlay with at least one fill piece attached to the hooked surface of the carrier sheet; and
(v) detachably attaching the carrier sheet onto the area of uncovered hooks, the at least one fill piece and decorative piece together creating a field or background for the decorative inlay.
